(19) United States
(12) Patent Application Publication
(10) Pub. No.: US 2026/0106571 A1
(43) Pub. Date: Apr. 16, 2026

(54) DISTRIBUTED DAMPERS FOR SOLAR TRACKER SYSTEMS

(71) Applicant: Nextpower LLC, Fremont, CA (US)

(72) Inventors: Alessio Orsini, Menlo Park, CA (US); Alexander W. AU, Oakland, CA (US); Ricardo Delgado-Nanez, San Jose, CA (US)

(21) Appl. No.: 19/347,399

(22) Filed: Oct. 1, 2025

Related U.S. Application Data
(60) Provisional application No. 63/706,351, filed on Oct. 11, 2024.

(51) Int. Cl. H02S 20/32

(52) U.S. Cl. CPC H02S 20/32

(57) ABSTRACT

A solar tracking system including a plurality of solar tracker rows arranged in parallel in a north-south direction wherein each solar tracker row may include a plurality of support piers, a torque tube extending along the row in the north-south direction rotatably supported on the plurality of support piers, a plurality of solar modules coupled to the torque tube, and a plurality of dampers. A first set of support piers of the plurality of support piers each include one or more dampers of the plurality of dampers, and the first set of piers forming a repeating pattern of support piers along the plurality of support piers in the solar tracker row.

### RELATED APPLICATIONS

This application claims the benefit of U.S. Provisional Patent Application No. 63/706,351, filed Oct. 11, 2024, the entire contents of which are incorporated herein by reference.

### TECHNICAL FIELD

This disclosure relates generally to solar tracker systems, and more particularly to damping systems and methods for increasing solar tracker stability due to wind loads.

### BACKGROUND

Solar cells and solar panels are most efficient in sunny conditions when oriented towards the sun at a certain angle. Many solar panel systems are designed in combination with solar trackers, which follow the sun's trajectory across the sky from east to west to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds of individual solar modules that are mechanically coupled to support structures.

Adjusting massive solar trackers requires power to drive the solar array as it follows the sun. As will be appreciated, the greater the load, the greater the amount of power necessary to drive the solar tracker. An additional design constraint of such systems is the rigidity required to accommodate the weight of the solar arrays and at times significant wind loading.

Tortional excitation caused by wind loading exerts significant force upon the structure for supporting and the mechanisms for articulating the solar tracker. As such, increases in the size and number of components to reduce torsional excitation are required at varying locations along the length of the solar tracker. With these concerns in mind prior systems have typically driven the solar modules to a position where the loads created by the wind are reduced, but these typically come at the cost of energy production. For example, one methodology drives all of the solar trackers to a flat or 0 angle position relative to the ground. As can be appreciated, this significantly reduces the amount of energy being produced. The present disclosure seeks to address the shortcomings of prior tracker systems.

### SUMMARY

In general, the present disclosure relates to damping systems and methods for increasing solar tracker stability due to wind loads. In one example, a solar tracking system may include a plurality of solar tracker rows arranged in parallel in a north-south direction. Each solar tracker row may include a plurality of support piers, a torque tube extending along the row in the north-south direction rotatably supported on the plurality of support piers, a plurality of solar modules coupled to the torque tube, and a plurality of dampers. Rotation of the torque tube may change the orientation of an outer face of the plurality of supported modules and, the dampers being connected such that the rotation effectuates a compression or extension of the dampers. A set of support piers of the plurality of support piers each having one or more dampers of the plurality of dampers, the set of piers forming a repeating pattern of support piers along all of the plurality of support piers in the solar tracker row.

Additionally or alternatively, the repeating pattern of support piers may begin at a north end, a south end, or a center position of the tracker row.

Additionally or alternatively, the repeating pattern of support piers may begin at the north end, and the northern-most support pier of the plurality of piers may not have any dampers.

Additionally or alternatively, the repeating pattern of support piers may begin at the south end, and the southern-most support pier of the plurality of piers may not have any dampers.

Additionally or alternatively, the repeating pattern of support piers may begin at the center position, and a first support pier of the plurality of piers on a northern side of the center position may not have any dampers.

Additionally or alternatively, the repeating pattern of support piers may begin at a center position of the solar tracker row and extend towards a north end and a south end of the tracker row.

Additionally or alternatively, support piers of the plurality of support that are not in the repeating pattern of support piers may not have any dampers.

Additionally or alternatively, the upper damper mount may rotate with the rotation of the torque tube causing the wing to move in an arcuate path with the rotation of the torque tube.

Additionally or alternatively, the plurality of solar tracker rows may include exterior solar tracker rows and interior solar tracker rows, the interior solar tracker rows may be solar tracker rows positioned between two other solar tracker rows, the exterior solar tracker rows may be solar tracker rows with one other solar tracker row on one side of the exterior solar tracker row and no solar tracker row positioned on the other side, opposite the one side, of the exterior solar tracker row, and wherein each exterior solar tracker row may have more dampers than each of the interior solar tracker rows.

Additionally or alternatively, further including a set of support piers of the plurality of support piers that may not have any dampers mounted thereto, and wherein the one or more of the set of support piers are located between piers in the first set of the plurality of support piers.

In another example, a solar tracking system may include a plurality of solar tracker rows arranged in parallel in a north-south direction. Each solar tracker row may include a plurality of support piers, a torque tube extending along the row in the north-south direction rotatably supported on the plurality of support piers, a plurality of solar modules coupled to the torque tube, and a plurality of dampers. Rotation of the torque tube may change the orientation of an outer face of the plurality of supported modules and, the dampers being connected such that the rotation effectuates a compression or extension of the dampers. A first set of support piers of the plurality of support piers may each have a single damper of the plurality of dampers, the single damper in the first set operatively connected between the support pier and the eastern side of the torque tube forming an eastern damper, and a second set of support piers of the plurality of support piers may each have a single damper of the plurality of dampers, the single damper in the second set operatively connected between the support pier and the western side of the torque tube forming a western damper. The first set of piers and the second set of piers may form a repeating pattern of support piers along all of the plurality of support piers in the solar tracker row, the repeating pattern alternating between a support pier in the first set of support piers and a support pier in the second set of support piers.

Additionally or alternatively, further including a third set of support piers of the plurality of dampers which may each have two dampers of the plurality of dampers, one of the two dampers being operatively connected between the support pier and the eastern side of the torque tube and the second of the two dampers being operatively connected between the support pier and the eastern side of the torque tube.

Additionally or alternatively, the first set of piers, the second set of piers, and the third set of piers may form a second repeating pattern of support piers along all of the plurality of support piers in the solar tracker row.

Additionally or alternatively, the connection of the eastern damper to the eastern side of the torque tube may be a rotatable connection to a wing of an upper damper mount, the wing being positioned eastward of the torque tube.

Additionally or alternatively, an upper damper mount may rotate with the rotation of the torque tube causing the wing to move in an arcuate path with the rotation of the torque tube.

Additionally or alternatively, the connection of the eastern damper to the pier may be a rotatable connection to a fixed location on the pier, thereby permitting the damper to rotate about the fixed location on the pier.

Additionally or alternatively, the plurality of solar tracker rows may include exterior solar tracker rows and interior solar tracker rows, the interior solar tracker rows may be solar tracker rows positioned between two other solar tracker rows, the exterior solar tracker rows may be solar tracker rows with one other solar tracker row on one side of the exterior solar tracker row and no solar tracker row positioned on the other side, opposite the one side, of the exterior solar tracker row, and wherein each exterior solar tracker rows may have more dampers than each of the interior solar tracker rows.

Additionally or alternatively, further including a third set of support piers of the plurality of support piers, the third set of support piers may not have any dampers mounted thereto, and wherein the third set of support piers may be located between piers in the first set of the plurality of support piers.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of a solar tracker;

FIG. 2 is a schematic, top view of a solar tracking system;

FIG. 3 is a schematic side view of a solar tracker having a first arrangement of dampers disposed thereon;

FIG. 4 is a schematic top view of the solar tracker as in FIG. 2, including the first arrangement of dampers disposed thereon;

FIG. 5 is a schematic side view of the solar tracker having a second arrangement of dampers disposed thereon;

FIG. 6 is a schematic side view of a solar tracker having a third arrangement of dampers disposed thereon;

FIG. 7A is a schematic top view of a solar tracker having a fourth arrangement of dampers disposed thereon;

FIG. 7B is a schematic top view of a solar tracker having a fifth arrangement of dampers disposed thereon;

FIG. 7C is a schematic top view of a solar tracker having a sixth arrangement of dampers disposed thereon;

FIG. 7D is a schematic top view of a solar tracker having a seventh arrangement of dampers disposed thereon;

FIG. 7E is a schematic top view of a solar tracker having an eighth arrangement of dampers disposed thereon;

FIG. 7F is a schematic top view of a solar tracker having a ninth arrangement of dampers disposed thereon;

FIG. 7G is a schematic top view of a solar tracker having a tenth arrangement of dampers disposed thereon;

FIG. 8 is a side view of the dampers of the solar trackers as in FIGS. 3 to 6; and

FIG. 9 is a side view of an alternative connection to a pier of the solar tracker.

### DETAILED DESCRIPTION

The present disclosure is directed to distributed damping systems and methods for increasing solar tracker stability due to wind loads. Wind stability of solar tracker systems can be affected by several variables. A structure that moves enough in the wind that the motion of the structure changes the wind flow around it is aeroelastic. If this change makes things worse, then it is unstable. This is aeroelastic dynamic instability due to wind. This dynamic instability could happen at wind speeds well below the 300-year return period design wind speed. In embodiments, dampers can be distributed on piers of the solar tracker in an alternating configuration to reduce oscillations. The present disclosure describes design strategies that can be adopted to minimize dynamic instability.

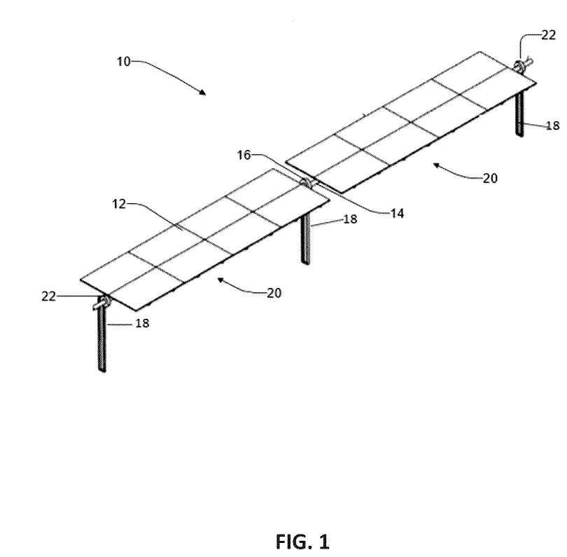

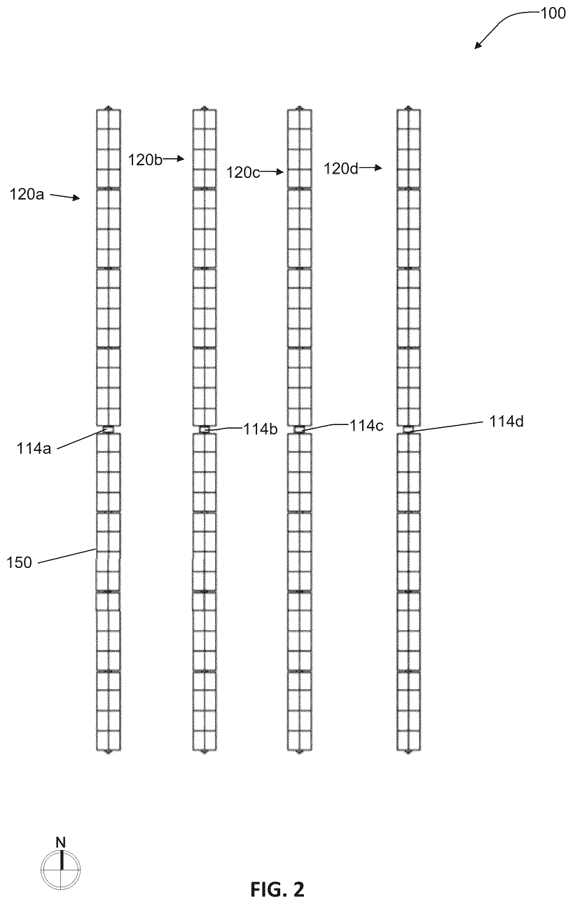

Referring now to the drawings, FIG. 1 illustrates a perspective view of a common arrangement of a solar tracker 10 provided in accordance with the present disclosure. The solar tracker 10 has bays 20 defined by the distance between ground piers 18 (generally referenced herein as piers 18). The solar tracker 10 may be a part of a larger solar tracker system that may include a plurality of solar trackers 10 arranged in rows, an example of which is shown in FIG. 2\, where each row of solar trackers 10 may be referred to as a solar tracker row. FIG. 1 illustrates two bays 20 of the solar tracker 10. However, it will be appreciated that the solar tracker 10 may include four bays, six bays, ten bays, twenty bays, or any other suitable number of bays as desired. At each pier 18 is either a bearing 22 or, as shown in FIG. 1, a drive mechanism 16 shown, for example, near the center of the solar tracker 10. Each of the bearings 22 and the drive mechanism 16 are supported by one of the piers 18. Activation of the drive mechanism 16 rotates a torque tube 14 about an axis of rotation and thus rotates one or more solar modules 12 mounted to the torque tube 14 such that the solar modules 12 can be oriented to a desired position. That desired position may be a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piers 18 is reduced or substantially eliminated and to absorb torsional loads applied to the torque tube 14 by wind loading. In addition, since there is just a single drive mechanism 16, the specifications for the torque tube 14 must also seek to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system.

The bracket system may take many forms including two pieces of shaped steel, which may be arranged to sandwich the solar modules 12, and may be configured to connect to a rail, which is then coupled to the torque tube 14.

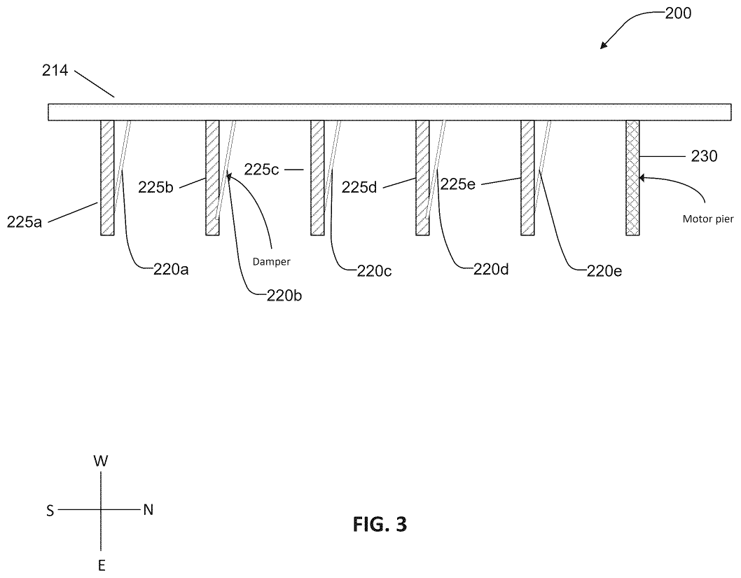

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44°range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. Each of the solar tracker rows 120 may further include a plurality of dampers, as shown in FIGS. 3 to 7G. In some examples, the exterior solar tracker rows may each include more dampers than each of the interior solar tracker rows, and in other examples, the interior solar tracker rows may each include more dampers than each of the exterior solar tracker rows. The solar tracker rows 120 may be composed of a plurality of solar modules 150 arranged in a north-south longitudinal orientation to form the solar tracker rows 120. Each one of the plurality of solar modules 150 may be supported on a torque tube 114a, 114b, 114c, 114d (generally referred to herein as torque tube 114), which in turn is supported by a plurality of support piers (not explicitly shown in FIG. 2). As shown, the solar tracker rows 120 may be separated by a space sufficient to allow machinery to travel therethrough to allow for cleaning and maintenance.

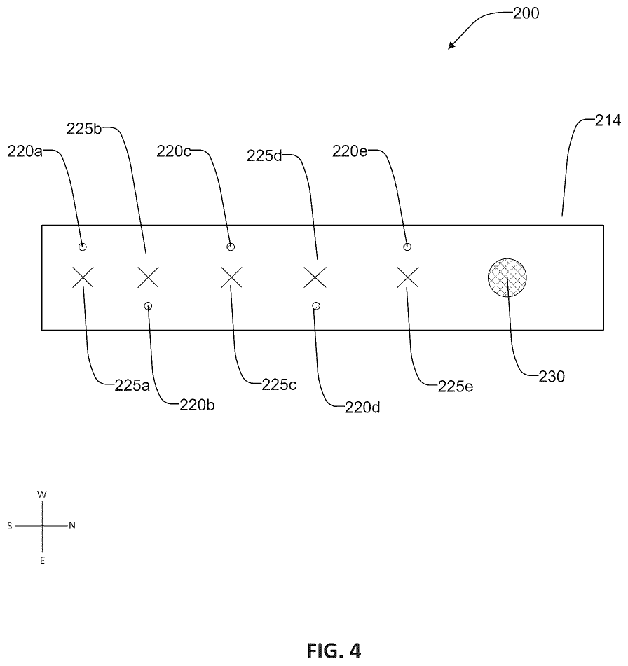

FIG. 3 is a schematic side view of an example solar tracker row 200 having a first arrangement of dampers 220a, 220b, 220c, 220d, 220e (generally referred to herein as dampers 220) disposed thereon, and FIG. 4 is a top view of the solar tracker row 200, as in FIG. 3. The solar tracker row 200 may be an example of one of the solar tracker rows of FIG. 2. The solar tracker row 200 may be part of a larger solar tracker system, such as, for example solar tracker system 100. The solar tracker row 200 may include a plurality of support piers 225a, 225b, 225c, 225d, 225e (generally referred to herein as support piers 225). The support piers 225 may be disposed in spaced relation to one another and embedded into the earth. A torque tube 214 may be configured to extend along solar tracker rows (e.g., solar tracker rows 120) between each adjacent support pier 225 in a north-south direction and may be rotatably supported on each support pier 225. The torque tube 214 may further be configured to be coupled to and support a plurality of solar modules (e.g., solar modules 12), although this is not explicitly shown in FIG. 3.

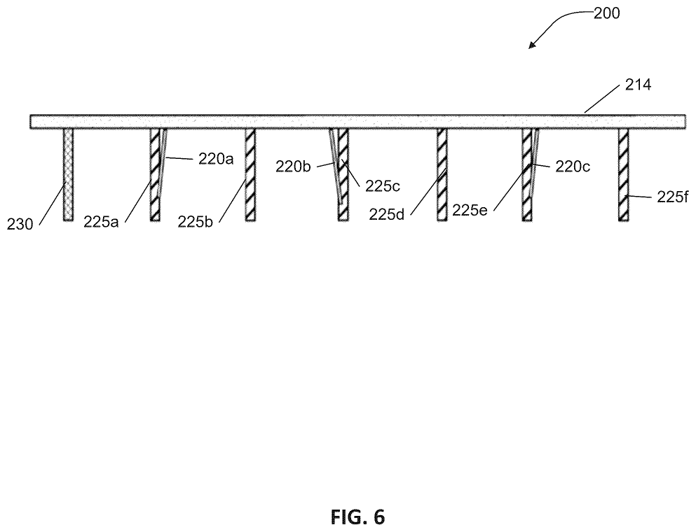

As shown in FIG. 3, a first set of support piers of the plurality of support piers 225 may include support piers 225b and 225d. The support piers 225b, 225d may each include a single damper 220b, 220d, respectively, of the plurality of dampers 220. The single dampers 220b, 220d in the first set of support piers 225b, 225d may be operatively connected between the support pier 225b, 225d and an eastern side of the torque tube 214 forming an eastern damper 220b, 220d. A second set of support piers 225a, 225c, 225e of the plurality of support piers 225 may each include a single damper 220a, 220c, 220e, respectively, of the plurality of dampers 220. The single damper 220a, 220c, 220e in the second set of support piers 225a, 225c, 225e may be operatively connected between the support pier 225a, 225c, 225e and a western side of the torque tube 214 forming a western damper 220a, 220c, 220e. In some cases, the first set of support piers 225b, 225d and the second set of support piers 225a, 225c, 225e may form a repeating pattern of support piers 225 along all of the plurality of support piers 225 in the solar tracker row 200. The repeating pattern may alternate between a support pier 225 in the first set of support piers 225b, 225d and a support pier 225 in the second set of support piers 225a, 225c, 225e, as shown in FIGS. 3 to 4. In some cases, a third set of support piers may be located between piers in the first set of the plurality of support piers 225b, 225d. The third set of support piers of the plurality of support piers 225 may not include any dampers mounted thereto, as shown in FIG. 6. In some cases, the third set of support piers of the plurality of support piers 225 may each include two dampers of the plurality of dampers 220 where one of the two dampers may be operatively connected between the support pier and the eastern side of the torque tube 214, and the second of the two dampers may be operatively connected between the support pier and the western side of the torque tube. In such cases, the first set of support piers 225b, 225d, the second set of support piers 225a, 225c, 225e, and the third set of support piers may form a second repeating pattern of support piers 225 along all of the plurality of support piers 225 in the solar tracker row 200.

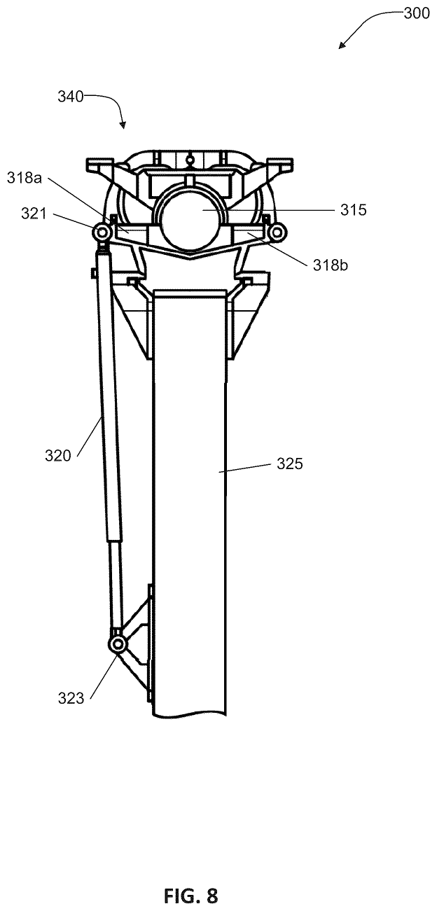

Rotation of the torque tube 214 may change an orientation of an outer face of the plurality of supported modules (e.g., solar modules 12, 150) eastward, whereas the dampers 220 may be connected such that rotation of the torque tube 214 effectuate a compression of the eastern damper 220b, 220d between the support pier 225b, 225d and the eastern side of the torque tube 214. In some cases, the connection of the eastern damper 220b, 220d to the eastern side of the torque tube 214 may be a rotatable connection to a wing (further described in reference to FIG. 8) of an upper damper mount, whereas the wing may be positioned eastward of the torque tube. Further, in some examples, the connection of the eastern damper 220b, 220d to the support pier 225b, 225d may be a rotatable connection to a fixed location on the pier 225b, 225d, thereby permitting the damper 220b, 220d to rotate about the fixed location on the pier 225b, 225d. Likewise, rotation of the torque tube 214 may change the orientation of an outer face of the plurality of supported modules (e.g., solar modules 12, 150) westward may effectuate a compression of the western damper 220a, 220c, 220e between the support pier 225a, 225c, 225e and the western side of the torque tube 214. In some cases, the connection of the western damper 220a, 220c, 220e to the western side of the torque tube 214 may be a rotatable connection to a wing (further described in reference to FIG. 8) of an upper damper mount, whereas the wing may be positioned westward of the torque tube. Further, in some examples, the connection of the western damper 220a, 220c, 220e to the support pier 225a, 225c, 225e may be a rotatable connection to a fixed location on the pier 225a, 225c, 225e, thereby permitting the damper 220a, 220c, 220e to rotate about the fixed location on the pier 225a, 225c, 225e.

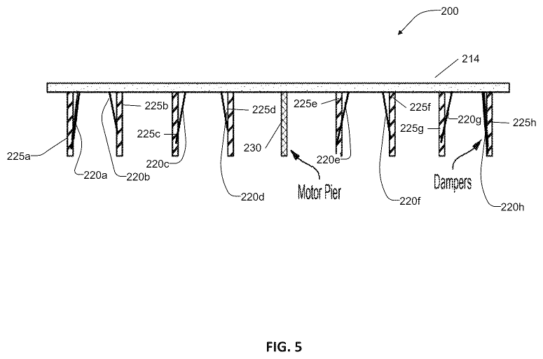

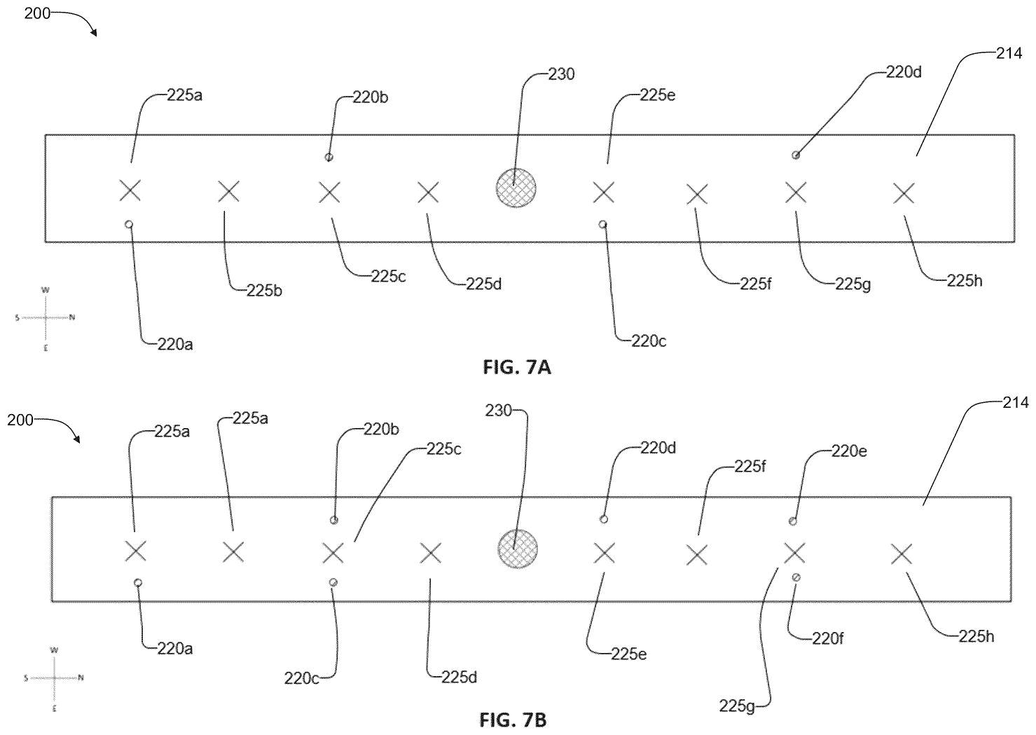

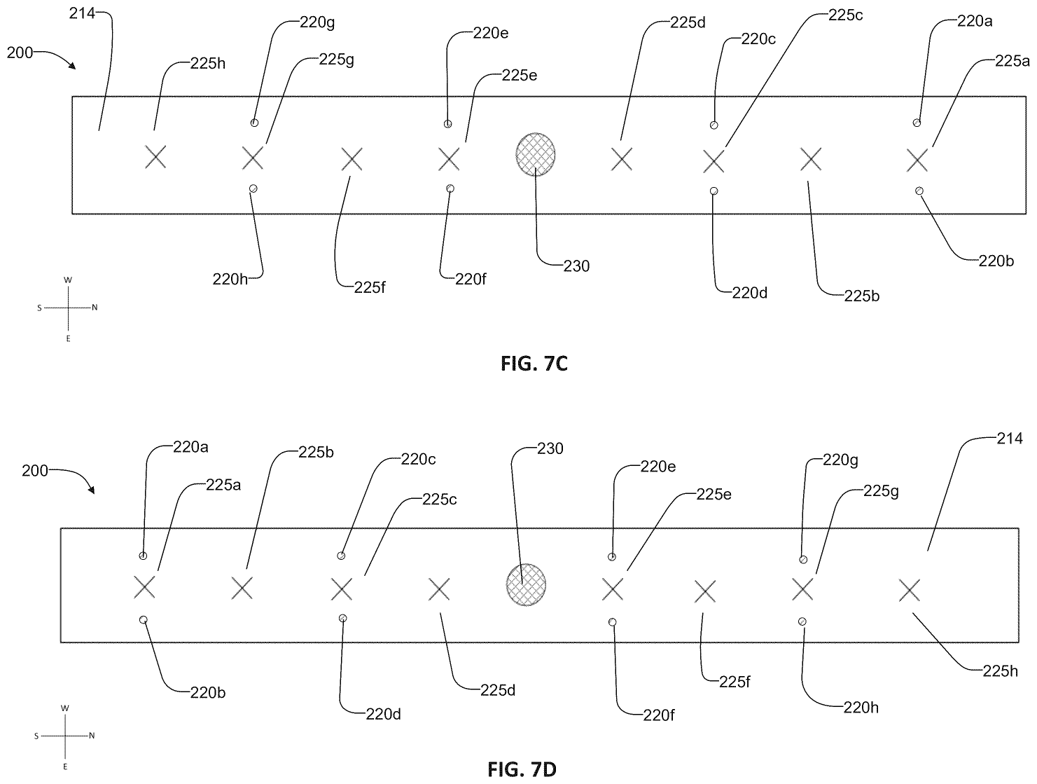

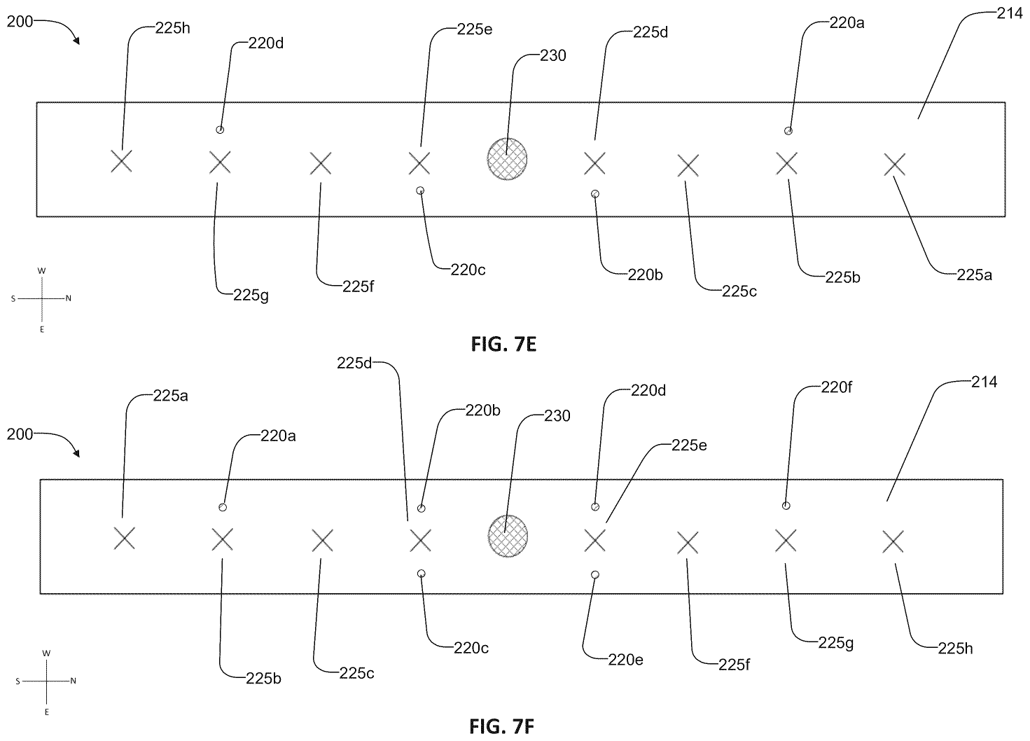

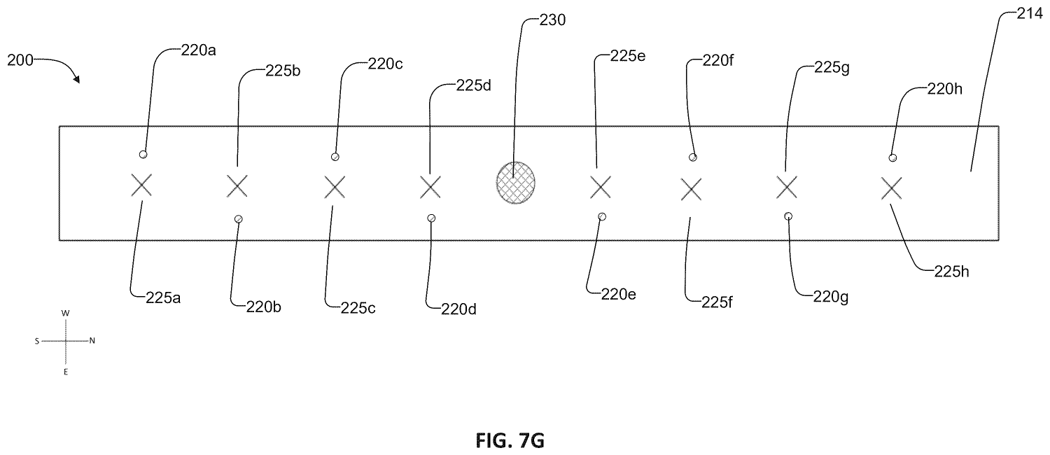

The solar tracker row 200 may include a motor pier 230, which may include a high efficiency drive mechanism mounted on the motor pier 230. As shown in FIG. 3, the motor pier 230 is positioned at one end of the solar tracker row 200. However, this is not always necessary. For example, the motor pier 230 could be positioned centrally (FIGS. 5, 7A to 7G) or at another end (FIG. 6). Further, the drive mechanism may not always be a high efficiency drive mechanism. Rather, the drive mechanism may be determined based on the energy necessary to rotate the torque tube 214. The drive mechanism may be a worm drive, a slew drive, or any other suitable drive.

The solar tracker row 200 may further include the plurality of dampers 220. The plurality of dampers 220 may be positioned throughout the solar trackers 200 and the solar tracker rows to distribute a wind load and control movement of the solar modules (e.g., solar modules 12). For example, the plurality of dampers 220 may alternate between an eastern side of the torque tube 214 and a western side of the torque tube 214 along the solar tracker row 200, and/or the solar tracker row (e.g., solar tracker row 120), as shown in FIG. 3.

FIG. 5 is a side view of the solar tracker row 200 having a second arrangement of dampers 220 disposed thereon, and FIG. 6 is a side view of the solar tracker row 200 having a third arrangement of dampers 220 disposed thereon. The solar tracker row 200 of FIG. 5 is like the solar tracker row 200 of FIGS. 3 to 4, except that the motor pier 230 is positioned in a central region of the solar tracker row 200. The solar tracker row 200 of FIG. 6 is like the solar tracker row 200 of FIGS. 3 to 5, except that the motor pier 230 is on one end and the third set of support piers of the plurality of support piers 225 do not include any dampers mounted thereto.

FIGS. 7A to 7G illustrate schematic top views of the solar tracker row 200 having a fourth, fifth, sixth, seventh, eighth, ninth, and tenth arrangement of dampers disposed thereon, respectively. The solar tracker row 200 of FIGS. 7A to 7G is like the solar tracker row 200 of FIGS. 3 to 4, except that the motor pier 230 is positioned in a central region of the solar tracker row 200. Further, the solar tracker row 200 of FIGS. 7A to 7G may each illustrate varying arrangements of repeating patters of support piers 225 including dampers 220 beginning at a north end, a south end, or a center position of the tracker row 200. While it is shown that the support piers 225 may include a repeating pattern of dampers 220 in FIGS. 7A to 7G, it may be contemplated that a further plurality of support piers (e.g., northern-most, southern-most shown in FIGS. 7A to 7D) not in the repeating pattern of support piers 225 do not have any dampers 220.

As shown in FIG. 7A, the repeating pattern of support piers 225 begins at the south end having a damper 220a on an eastern side of the support pier 225a, a second damper 220b positioned on a western side of the support pier 225c, a third damper 220c positioned on an eastern side of the support pier 225e, and a fourth damper 220d positioned on a western side of the damper 225g. This repeating pattern may continue for the entirety of the solar tracker row 200 wherein the northern-most support pier 225 may not include any dampers 220.

FIG. 7B illustrates a repeating pattern of support piers 225 beginning at the south end having a damper 220a on an eastern side of the support pier 225a, a second damper 220b on a western side of the support pier 225c and a third damper 220c on an eastern side of the support pier 225c, a fourth damper 220d on a western side of the support pier 225e, a fifth damper 220e on a western side of the support pier 225g and a sixth damper 220f on an eastern side of the support pier 225g. This repeating pattern may continue for the entirety of the solar tracker row 200 wherein the northern-most support pier 225 may not include any dampers 220.

7C illustrates a repeating pattern of support piers 225 beginning at a center position (e.g., the motor pier 230). In this example, the solar tracker row may include a damper 220a on a western side of the support pier 225a, a second damper 220b on an eastern side of the support pier 225a, a third damper 220c on a western side of the support pier 225c, a fourth damper 220d on an eastern side of the support pier 225c, a fifth damper 220e on a western side of the support pier 225e, a sixth damper 220f on an eastern side of the support pier 225e, a seventh damper 220g on a western side of the support pier 225g, and an eighth damper 220h on an eastern side of the support pier 225g. This repeating pattern may continue for the entirety of the solar tracker row 200 wherein the southern-most support pier 225 may not include any dampers 220. Further, the support pier 225d may be considered to be the first support pier 225d of the plurality of support piers 225 on a northern side of the center position (e.g., the motor pier 230), and the support pier 225d may not include any dampers 220.

7D illustrates a repeating pattern of support piers 225 beginning at the south end having a damper 220a on a western side of the support pier 225a, a second damper 220b on an eastern side of the support pier 225a, a third damper 220c on a western side of the support pier 225c, a fourth damper 220d on an eastern side of the support pier 225c, a fifth damper 225e on a western side of the support pier 225e, a sixth damper on an eastern side of the support pier 225e, a seventh damper 220g on a western side of the support pier 225g, and an eighth damper 220h on an eastern side of the damper 225g. This repeating pattern may continue for the entirety of the solar tracker row 200 wherein the northern-most support pier 225 may not include any dampers 220.

7E illustrates a repeating pattern of support piers 225 beginning at the center position (e.g., motor pier 230). In the example shown in FIG. 7E, a first damper 220a may be positioned on a western side of the support pier 225b, a second damper 220b on an eastern side of the support pier 225d, a third damper 220c on an eastern side of the support pier 225e, and a fourth damper 220d on a western side of the support pier 225g. In the example shown in FIG. 7E, the northern-most support pier 225a and the southern-most pier 225h of the plurality of support piers 225 may not include any dampers 220. This repeating pattern may continue for the entirety of the solar tracker row 200.

7F illustrates a repeating pattern of support piers 225 beginning at the center position (e.g., motor pier 230). In the example shown in FIG. 7E, a first damper 220a may be positioned on a western side of the support pier 225b, a second damper 220b on an eastern side of the support pier 225d, a third damper 220c on an eastern side of the support pier 225d, a fourth damper 220d on a western side of the support pier 225e, a fifth damper 220e on an eastern side of the support pier 225e, and a sixth damper 220f on a western side of the support pier 225g. In the example shown in FIG. 7F, the northern-most support pier 225h and the southern-most pier 225a of the plurality of support piers 225 may not include any dampers 220. This repeating pattern may continue for the entirety of the solar tracker row 200.

7G illustrates a repeating pattern of support piers 225 beginning at the south end having a damper 220a on aa western side of the support pier 225a, a second damper 220b on an eastern side of the support pier 225b, a third damper 220c on a western side of the support pier 225c, a fourth damper 220d on an eastern side of the support pier 225d, a fifth damper 220e on an eastern side of the support pier 225e, a sixth damper 220f on a western side of the support pier 225f, a seventh damper 220g on an eastern side of the support pier 225g, and an eighth damper 220h on a western side of the support pier 225h. This repeating pattern may continue for the entirety of the solar tracker row 200.

FIG. 8 is a side, elevation view of a damper assembly 300 that may be used with the solar tracker systems disclosed herein (e.g., solar tracker system 100, 200). The damper assembly 300 may include a damper 320, an upper damper mount 321 and a lower damper mount 323. The upper damper mount 321 includes a pair of side surfaces disposed in spaced relation to one another and an outer surface extending between each of the first and second side surfaces. The upper damper mount 321 includes a pair of wings 318a, 318b disposed in spaced relation to one another such that the upper damper mount 321 defines a generally arcuate or boomerang type configuration extending between respective first and second end portions, although it is contemplated that the upper damper mount 321 may define any suitable configuration, such as planar, amongst others. In one non-limiting embodiment, each of the pair of wings 318a, 318b form an angle of 15-degrees with respect to a horizontal axis, although it is envisioned that any suitable angle may be formed relative to the horizontal axis.

In some examples, the connection of an eastern damper to an eastern side of the torque tube is a rotatable connection to a wing 318a, 318b of the upper damper mount 321. In such cases, the wing 318a, 318b may be positioned eastward of the torque tube. When the upper damper mount 321 rotates with the rotation of the torque tube it causes the wing 318a, 318b to move in an arcuate path with the rotation of the torque tube. This movement of the wing 318a, 318b causes the damper 320 to move in a longitudinal direction. In some cases, the connection of the eastern damper to the pier is a rotatable connection to a fixed location on the pier, thereby permitting the damper to rotate about the fixed location on the pier.

An inner surface defines a groove 315 extending through each of the first and second side surfaces and only one portion of the outer surface. In this manner, the groove 315 defines a generally U-shaped profile, although it is contemplated that the groove 315 may define any suitable profile, such as square, rectangular, V-shaped, hexagonal, amongst others. The groove 315 is configured to receive a portion of a torque tube (e.g., torque tube 214) therein such that the torque tube may be selectively coupled thereto using a U-bolt or another suitable bracket or fastener.

Although generally illustrated as having a circular profile, it is contemplated that the pier 325 may include any suitable profile, such as square, oval, rectangular, octagonal, amongst others.

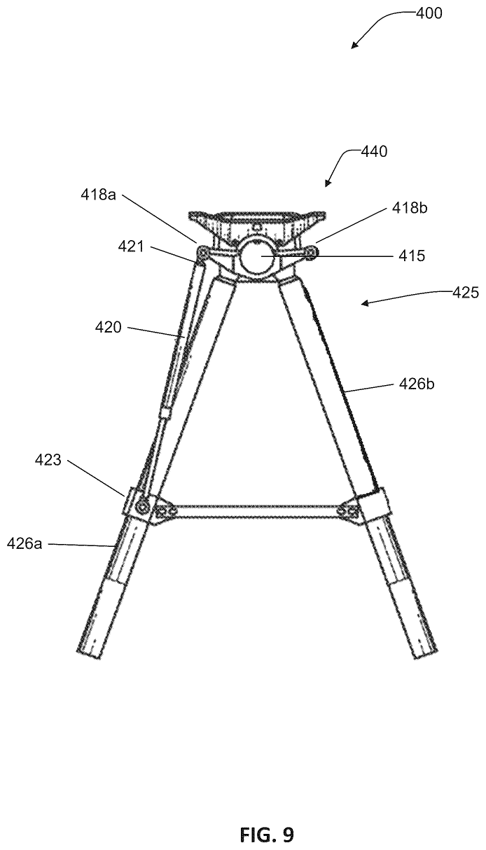

FIG. 9 is a side view of an alternative damper assembly 400 of a solar tracker disclosed herein (e.g., solar tracker 100, 200). The damper assembly 400 may be like damper assembly 300 shown in FIG. 8, except that the damper assembly 400 includes a pier 425 having an “A” profile. As can be seen in FIG. 9, the pier 425 is formed from a tube forming a generally “A” profile. In this manner, the pier 425 defines a pair of legs 426a, 426b and a crown 427 at a center portion thereof. Each of the pair of legs 426a, 426b terminates at a mounting plate that is coupled thereto using any suitable means, such as fasteners, welding, adhesives, amongst others. The pier 425 is formed from a unitary piece (e.g., a length of tube or pipe) that has been bent or otherwise formed into the generally “A” profile. In some embodiments, the pier 425 may be formed from multiple pieces that have been coupled to one another by means of welding, adhesives, fasteners, amongst others.

Although generally illustrated as having a circular profile, it is contemplated that the pier 425 may include any suitable profile, such as square, oval, rectangular, octagonal, amongst others.

Various non-limiting exemplary embodiments have been described. It will be appreciated that suitable alternatives are possible without departing from the scope of the examples described herein.

1. A solar tracking system, comprising:
a plurality of solar tracker rows arranged in parallel in a north-south direction;
each solar tracker row including:
a plurality of support piers;
a torque tube extending along the row in the north-south direction rotatably supported on the plurality of support piers;
a plurality of solar modules coupled to the torque tube; and
a plurality of dampers, and
rotation of the torque tube changes the orientation of an outer face of the plurality of supported modules and, the dampers being connected such that the rotation effectuates a compression or extension of the dampers; and
a set of support piers of the plurality of support piers each having one or more dampers of the plurality of dampers, the set of piers forming a repeating pattern of support piers along all of the plurality of support piers in the solar tracker row.

2. The solar tracking system of claim 1, wherein the repeating pattern of support piers begins at a north end, a south end, or a center position of the tracker row.

3. The solar tracking system of claim 2, wherein the repeating pattern of support piers begins at the north end, and the northern-most support pier of the plurality of piers does not have any dampers.

4. The solar tracking system of claim 2, wherein the repeating pattern of support piers begins at the south end, and the southern-most support pier of the plurality of piers does not have any dampers.

5. The solar tracking system of claim 2, wherein the repeating pattern of support piers begins at the center position, and a first support pier of the plurality of piers on a northern side of the center position does not have any dampers.

6. The solar tracking system of claim 1, wherein the repeating pattern of support piers begin at a center position of the solar tracker row and extends towards a north end and a south end of the tracker row.

7. The solar tracking system of claim 1, wherein support piers of the plurality of support that are not in the repeating pattern of support piers do not have any dampers.

8. The solar tracking system of claim 1, wherein the upper damper mount rotates with the rotation of the torque tube causing the wing to move in an arcuate path with the rotation of the torque tube.

9. The solar tracking system of claim 1, wherein the plurality of solar tracker rows includes exterior solar tracker rows and interior solar tracker rows, the interior solar tracker rows are solar tracker rows positioned between two other solar tracker rows, the exterior solar tracker rows are solar tracker rows with one other solar tracker row on one side of the exterior solar tracker row and no solar tracker row positioned on the other side, opposite the one side, of the exterior solar tracker row, and wherein each exterior solar tracker row has more dampers than each of the interior solar tracker rows.

10. The solar tracking system of claim 1, further comprising a set of support piers of the plurality of support piers that do not have any dampers mounted thereto, and wherein the one or more of the set of support piers are located between piers in the first set of the plurality of support piers.

11. A solar tracking system, comprising:
a plurality of solar tracker rows arranged in parallel in a north-south direction; each solar tracker row including:
a plurality of support piers;
a torque tube extending along the row in the north-south direction rotatably supported on the plurality of support piers;
a plurality of solar modules coupled to the torque tube; and
a plurality of dampers, and
rotation of the torque tube changes the orientation of an outer face of the plurality of supported modules and, the dampers being connected such that the rotation effectuates a compression or extension of the dampers;
a first set of support piers of the plurality of support piers each having a single damper of the plurality of dampers, the single damper in the first set operatively connected between the support pier and the eastern side of the torque tube forming an eastern damper,
a second set of support piers of the plurality of support piers each having a single damper of the plurality of dampers, the single damper in the second set operatively connected between the support pier and the western side of the torque tube forming a western damper,
the first set of piers and the second set of piers forming a repeating pattern of support piers along all of the plurality of support piers in the solar tracker row, the repeating pattern alternating between a support pier in the first set of support piers and a support pier in the second set of support piers.

12. The solar tracking system of claim 10 further comprising, a third set of support piers of the plurality of dampers each having two dampers of the plurality of dampers, one of the two dampers being operatively connected between the support pier and the eastern side of the torque tube and the second of the two dampers being operatively connected between the support pier and the eastern side of the torque tube.

13. The solar tracking system of claim 12, wherein the first set of piers, the second set of piers, and the third set of piers forming a second repeating pattern of support piers along all of the plurality of support piers in the solar tracker row.

14. The solar tracking system of claim 11, wherein the connection of the eastern damper to the eastern side of the torque tube is a rotatable connection to a wing of an upper damper mount, the wing being positioned eastward of the torque tube.

15. The solar tracking system of claim 11, wherein an upper damper mount rotates with the rotation of the torque tube causing the wing to move in an arcuate path with the rotation of the torque tube.

16. The solar tracking system of claim 11, wherein the connection of the eastern damper to the pier is a rotatable connection to a fixed location on the pier, thereby permitting the damper to rotate about the fixed location on the pier.

17. The solar tracking system of claim 11, wherein the plurality of solar tracker rows includes exterior solar tracker rows and interior solar tracker rows, the interior solar tracker rows are solar tracker rows positioned between two other solar tracker rows, the exterior solar tracker rows are solar tracker rows with one other solar tracker row on one side of the exterior solar tracker row and no solar tracker row positioned on the other side, opposite the one side, of the exterior solar tracker row, and wherein each exterior solar tracker rows has more dampers than each of the interior solar tracker rows.

18. The solar tracking system of claim 10, further comprising a third set of support piers of the plurality of support piers, the third set of support piers do not have any dampers mounted thereto, and wherein the third set of support piers are located between piers in the first set of the plurality of support piers.
